(19) United States
(12) Patent Application Publication
(10) Pub. No.: US 2004/0186867 A1
(43) Pub. Date: Sep. 23, 2004

(54) Method and device for reducing the crest factor of a signal

(75) Inventor: Heinrich Schenk, Munchen (DE)

Correspondence Address: Maginot, Moore & Beck, Bank One Tower, 111 Monument Circle, Suite 3000, Indianapolis, IN, 46204, US

(73) Assignee: Infineon Technologies AG, Munich (DE)

(21) Appl. No.: 10/763,045

(22) Filed: Jan. 21, 2004

(30) Foreign Application Priority Data
Jan. 21, 2003 (DE) 103 02 113.2

(51) Int. Cl. G06F 17/10

(52) U.S. Cl. 708/300; 375/285; 375/296; 708/400

(57) ABSTRACT

In order to change and, in particular, reduce the crest factor in a signal which is used, in particular, for data transmission by the method of discrete multitone modulation, it is known to store the signal in the form of individual sampling values in a signal vector (y), as a function of which a correction vector (Δy) is calculated for superimposition of the signal vector (y). The correction vector (Δy) is calculated here as a function of a maximum element of the signal vector (y) and reduces this maximum value in a targeted manner. In order to be able to reduce new maximum values of the signal vector (y) occurring after the reduction of a first maximum value, according to the invention the correction vector is windowed, so it acts with differing strength on different sections of the signal vector (y) or in that with the windowed correction vector (Δy) individual maximum values in the signal vector (y) can be reduced in a targeted manner. Therefore, correction vectors (Δy) can be superimposed a plurality of times in succession in the signal vector (y) in order to reduce iteratively large values in the signal vector (y), if in the consecutively used correction vectors (Δy) the window area is at another respective position.

The invention relates to a method and a device set up to carry out the method for changing and, in particular, reducing the crest factor of a signal, the signal being described by a signal vector and at least one correction vector being calculated to change the crest factor of the signal as a function of the signal vector and added to the signal vector.

The crest factor of a signal provides the ratio of the peak value of the signal to the effective value thereof. With an increasing crest factor, the outlay which is required for linear processing of the signal also increases. The signal processing in this context comprises, for example, digital-analogue conversion, analogue-digital conversion, analogue or digital filtering, amplification or attenuation and transmission via a line.

In particular signals which have been generated in the use of discrete multitone modulation, may have a high crest factor. Discrete multitone modulation (DMT)—also multi-carrier modulation—is a modulation method which is suitable, in particular, for transmission of data via linearly distorting channels. Application sectors for discrete multitone modulation are, for example, digital radio DAG (Digital Audio Broadcast) called OFDM (Orthogonal Frequency Division Multiplex) and the transmission of data via telephone lines called ADSL (Asymmetric Digital Subscriber Line).

In this modulation method, the transmitting signal is composed of many sinusoidal signals, each individual sinusoidal signal being modulated both with respect to amplitude and to phase. A number of quadrature amplitude-modulated signals are thus obtained. For implementation, inverse Fourier transformation, in particular, inverse FFT (Fast Fourier Transformation) can be used in the transmitter, and normal Fourier transformation, in particular, FFT (Fast Fourier Transformation) can be used in the receiver.

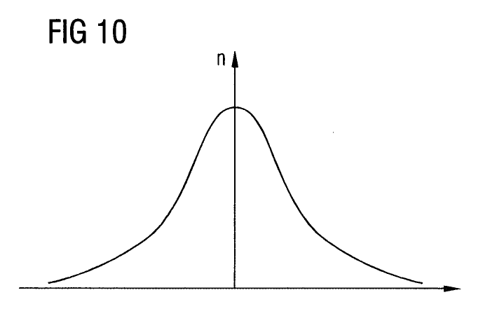

A data transmission system using the discrete multitone modulation, for example, has a coding device which assigns the bits of a serial digital data signal which is to be transmitted to individual carrier frequencies and generates a digital signal vector in the frequency domain. The signal vector is transformed in the frequency domain into the time domain by an inverse fast Fourier transformation (IFFT). The signal shown by the signal vector generated in the time domain has an amplitude distribution which approximately corresponds to a Gauss distribution. A graph of a distribution of this type is shown in FIG. 10, various amplitude values being plotted on the horizontal axis to the right and the frequency n of the occurrence of the individual amplitude values being plotted on the horizontal axis at the top. As can be seen in the graph, even very high amplitude values with a certain, even if low, probability can occur. The crest factor of the signal is therefore very large, so the components of the signal transmission chain following the FFT have to have a very large dynamic range or a high resolution to avoid distortions. To keep the outlay required for this as low as possible, it is known, to reduce the crest factor of the signal in the time domain.

Thus, a method for reducing the crest factor of a signal is known from DE 19850642 A1, in which a correction vector which is added to the signal is calculated from the signal vector, the correction vector being selected such that, on the one hand, the crest factor is reduced and, on the other hand, the spectral components of the correction vector are only located at half the sampling frequency of the signal or at the frequency 0, so only spectral components which do not, or only slightly, disturb the data to be transmitted are added by the correction vector.

Methods are also known in which, to reduce the crest factor in discrete multitone modulation, carrier frequencies are used which are not used for data transmission. These unused carrier frequencies are in particular distributed uniformly over the fundamental frequency range and thus disadvantageously narrow the bandwidth available for data transmission. A method of this type is known from M. Friese, “Mehrträgermodulation mit kleinem Crest-Faktor”, (Multicarrier modulation with small crest factor) VDI Fortschritt-Berichte, (VDI progress report), series 10, No. 472, Dusseldorf 1997. Furthermore, in this method, a high outlay for circuitry is disadvantageously also required to select and occupy the unused carrier frequencies, and it is necessary to inform a receiver which carrier frequencies have been used to reduce the crest factor.

When the crest factor of the signal is reduced, in that at least one correction vector is superimposed on the signal vector, this takes place with the aim of reducing at least one maximum value in the signal vector and therefore the crest factor thereof. After the superimposition of the at least one correction vector inevitably new maximum values are produced at another position which are less than those previously compensated. These newly produced maximum values can no longer be reduced as in the case of a repeated superimposition with at least one correction vector, the previously attained reduction of the original maximum values would be at least partially reversed again. Therefore, the crest factor of the signal can only be reduced to a very limited extent by the known method by superimposition of at least one correction vector.

The object of the present invention is based on providing a method and a correspondingly designed device for changing the crest vector of a signal by means of at least one correction vector calculated as a function of the signal vector and added thereto, wherein the crest factor is changed to an increased degree and is in particular reduced.

This object is achieved according to the invention by a method with the features of claim 1 and a device with the features of claim 23. The sub-claims each define preferred and advantageous embodiments of the present invention.

According to the invention, at least one correction vector, of which the elements describe a signal, of which the envelope curve has at least one extreme value, is superimposed on the signal vector. This expresses the fact that the envelope curve of the at least one correction vector has a ripple factor and therefore acts differently on different sections of the signal vector. It is thus possible to reduce maximum values in the signal vector in a targeted manner and in the process influence other ranges of the signal vector only to a limited extent or not at all. This has the result that, for example, after use of a first correction vector with the strongest action in the range of a first maximum value of the signal vector, a second maximum value of the signal vector produced thereafter can be reduced by use of a second correction vector which now acts most strongly in the region of the second maximum value of the signal vector. This method can be used substantially as often as desired, in order to reduce the maximum value newly produced after the superimposition of a correction vector at another position. In this manner, the crest factor of the signal can be reduced iteratively substantially more strongly. After a specific number of steps in which a respective new correction vector is calculated and superimposed, the method can be interrupted as the desired reduction of the crest factor generally decreases from step to step.

Basically, a rippled envelope curve of the correction vector means that the correction vector has additional spectral components in addition to a base frequency. These spectral components depend on the form of the envelope curve. If, for example, the signal vector is only to be changed in a very small range with the correction vector in order to reduce the maximum value there in a targeted manner, without influencing the remaining signal vector, this means that the spectrum is widened at the base frequency of the correction vector at the sides or has side lobes which extend beyond a specific spectral range. If, on the other hand, an elongated envelope curve is used, with which individual sections or maximum values of the signal vector can disadvantageously be influenced in a less targeted manner, the spectral line widens less strongly at the base frequency of the correction vector, so the entire frequency spectrum of the correction vector is in a narrower spectral range.

The spectral range in which the correction vector has components, cannot, disadvantageously, be used for information transmission. This means that, depending on the selection of the envelope curve of the correction vector more or less frequencies in the fundamental frequency range of the signal are disturbed. In this instance, the fact applies that the disturbed signal range is all the wider, the more limited sections of the signal vector can be influenced in a targeted manner with the correction vector.

Advantageously, the correction vector is generated by multiplication of a base vector by a window function or by windowing a base vector. This means a multiplication of two signals in the time domain which means a convolution in the frequency domain. It is assumed hereinafter that a window function has a pronounced maximum and falls on either side in particular to zero. After multiplication by a base vector, a correction vector results therefrom which assumes high values in one range and the values of which outside this range are small and, in particular, zero.

The base vector describes a signal with specific spectral components which preferably lie at the edge or outside a useful spectral range for information transmission.

If the base vector is to be used which is calculated by scaling a sequence of alternately −1 and +1, the base vector only has a spectral component at half the sampling frequency f_{A}. When the elements of the base vector have the running index i, the elements of the base vector gᵢ can be calculated as follows:

$${g}_{i} = - \frac{1}{2} \cdot {( - 1 )}^{i} ( max ( {( - 1 )}^{i} \cdot {y1}_{i} ) + min ( {( - 1 )}^{i} \cdot {y1}_{i} ) ) .$$

In this instance, max denotes the largest element of a signal vector and min the smallest element of a signal vector. The correction vector is then calculated by windowing the base vector and added to the signal vector, the window function having a value range of up to +1.

However, in an advantageous embodiment, the correction vector is calculated with the introduction of an auxiliary vector Xh to reduce the greatest element of the signal vector with respect to amount, as follows. In this instance, a window function w is started from which only has values differing from zero in one window area and thus defines a window area with M values and a running index μ of 0 to M−1, the window area being placed with respect to the signal vector with N elements in such a way that the maximum element of the signal vector lies in the centre of the window area. The elements of the signal vector which lie in the window area are copied for further calculation in the auxiliary vector Xh which like the window area M has values with the running index p from 0 to M−1. If i is the running index for the signal vector and iₘₐₓ is the index for the largest element of the signal vector, the index i_{μ} for an element of the signal vector adopted into the auxiliary vector Xh can be calculated as follows, where i is the index of the element in the signal vector and μ is the index of the element in the auxiliary vector Xh.

i_{μ}iₘₐₓ−½*(M−1)+μ when 0<=(iₘₐₓ−½*(M−1)+μ)<N,

i_{μ}=iₘₐₓ−½*(M−1)+μ+N when (iₘₐₓ−½*(M−1)+μ)<0, and

i_{μ}=iₘₐₓ−½*(M−1)+μ−N when (iₘₐₓ−½*(M−1)+μ)>=N.

The largest element Xhₘₐₓ is located at the position 0.5* (M−1)+1 in the auxiliary vector. A scaling factor dₒₚₜ is calculated for the correction vector with the aid of the elements of the auxiliary vector Xh and the window function w(μ). For this purpose, for each μ from 0 to M−1 the expression (Xhₘₐₓ+Xh_{μ})/(1+w(μ)) is evaluated and the minimum result for this expression adopted as dₒₚₜ, so

$${d}_{opt} = Min ( \frac{X {h}_{max} + X {h}_{μ}}{1 + w ( μ )} )$$

applies.

In addition, a sign Vz, which can assume the value +1 or −1, is calculated as follows, to discern whether the largest element with respect to amount to be corrected is a minimum or a maximum.

$$Vz = sign ( Xh ( \frac{M - 1}{2} + 1 ) )$$

The elements of the correction vector Δy_{μ} are calculated for the window area as follows:

Δy_{μ}=−Vz·dₒₚₜ·(−1)^{μ}·w(μ).

Outside the window area, the elements of the correction vector Δy are zero, so the elements of the signal vector are only superimposed with the elements Δy_{μ} within the window area, the index μ of the correction vector having to be adapted to the index i of the signal vector. The computing outlay for dₒₚₜ can thus be considerably reduced when not all the values of the auxiliary vector have to be used for the evaluation of the above-mentioned expression, but only a few and only the largest with respect to amount with a negative sign. The optimum value for dₒₚₜ can thereby be determined with at most three to four calculations.

The maximum value of a signal vector is reduced with the above-described algorithm, without changing local maximum values lying more remote. Therefore, a new peak value may occur at another position, so it may be reasonable to repeat the correction a plurality of times. The reasonable number of iterations also depends here on the length of the window area.

The window function may obviously also be designed such that it has two or else more ranges in which the elements differ from zero, so two or more ranges of the signal vector may be influenced. A window function of this type may, for example, be achieved by the addition of a plurality of window functions, in which the local maximum is located in each case at another position. With the aid of a window function of this type with a plurality of local maximum values a plurality of local extreme values can be influenced simultaneously in the signal vector, and in particular reduced. The following considerations always relate, however, to a window function with a local maximum or extreme value, the statements also applying to window functions with a plurality of local extreme values, optionally with changes and/or restrictions.

The window function is advantageously selected such that the range around the local maximum is as narrow as possible, but the spectrum of the base vector is only slightly widened. These basically opposing requirements can be met to differing degrees, wherein window functions which meet the two requirements better generally disadvantageously require a high calculation outlay. The simplest example of a window function of this type is the rectangular window, the length of which extends only over part of the length of the base vector. A triangular window, a Von-Hann window, a Gauss window, a Hamming window or a Blackman window can also be used, with basically any desired window functions being conceivable. Advantageous window functions are generally calculated on the basis of a sinusoidal or cosinusoidal function.

In an advantageous embodiment, the signal is a carrier of data, wherein all spectral components of the data lie below the sampling frequency of the signal divided by 2^{N+1}, N being integral and >=1. This means that the used frequency range only extends at maximum up to a ¼ of the sampling frequency or up to half the Nyquist frequency. In this case, the elements of the signal vector can be cyclically alternately divided over 2^{N} part signal vectors and a correction vector can be calculated independently for each part signal vector. After the addition of the respectively calculated correction vectors to the respective part signal vector, the elements of the part signal vectors are cyclically alternately combined again to form an output signal vector. This method is particularly recommended, in particular in cases in which the sampling frequency of the signal is increased and, in particular, doubled, without the spectral range of the information or data contained being increased. This occurs, in particular, in deep-pass filters, if, for example, N=1 and therefore the spectral range of the information only goes to half the Nyquist frequency. The elements of the signal vector are then divided over two part signal vectors for which a suitable correction vector to reduce the crest factor can be calculated, independently of one another in each case.

After transmission of the signal vector via a line to the receiver, the received signal vector is converted back into the frequency domain on the receiver side generally by means of a normal Fourier transformation and, in particular a fast Fourier transformation. Generally there is a continuous signal on the transmitter side which is divided for transmission into time sections which are transmitted in the form of a respective signal vector to the receiver. The transmission path to the receiver, owing to inserted filters and the line, has a specific transmission behaviour which causes transient reactions with respect to the signal form of the transmitted signal vector. This has the result that on the receiver side the signal form of the signal vector is more strongly disturbed at the beginning. This makes equalising more difficult on the receiver side, as periodic disturbances which have a uniform effect over the entire length of the received signal vector can be more easily equalised than aperiodic disturbances which only occur in one section of the signal vector and are caused, for example, by the transient reactions. For this reason, it may advantageously be provided that the signal vector is lengthened at the front or back by a prefix or a guard interval. For this purpose, part of the signal vector from the opposing second end of the signal vector is added to a first end of the signal vector, the signal vector being lengthened cyclically. If, for example, one part is placed at the end of the signal vector as a prefix in front of the signal vector, the transmission path including all channel and filter distortions during this prefix can already respond, so ideally the transmission path at the beginning of the signal vector is already in the responded state and the received signal vector can be more easily equalised. For this purpose, the signal vector together with the prefix and guard interval are received on the receiver side and only the signal vector without prefix and guard interval is supplied for signal processing by, in particular, inverse Fourier transformation.

If in a transmission method using a prefix and guard interval, the crest factor is to be changed by means of a superimposed correction vector, the following has to be taken into account. The correction vector basically has to be adapted to the length of the signal vector. When the correction vector is superimposed before addition of the prefix or the guard interval, the correction vector has the length of the signal vector, so with the addition of the prefix or guard interval the already superimposed correction vector is also cyclically updated. If the correction vector is superimposed after addition of the prefix or guard interval, the correction vector has to have the length of the signal vector plus the guard interval.

When the guard interval is added after the addition of the correction vector, the calculation of the correction vector can be carried out as described above, as when the guard interval is added, the corresponding section of the signal vector is adopted together with a correction vector optionally acting there. If, on the other hand, the guard interval is added before the addition of the correction vector, it must be taken into account where a window area with values of the correction vector differing from zero lies with respect to the signal vector and the guard interval. If the window area lies completely within the signal vector and outside the guard interval, the correction vector can be calculated just as described before. If, on the other hand, the window area lies at the edge of the signal vector in such a way that it extends beyond one end of the signal vector, the projecting part of the window area has to be cyclically updated at the other end of the signal vector, in other words in some circumstances also at the boundary between the guard interval and signal vector and not at the beginning of the vector composed of the guard interval and signal vector. In this latter case, the correction vector must basically be calculated such that even after its later addition to the signal vector already provided with the guard interval the same total vector is produced as if the signal vector had first been extended with the guard interval and then the correction vector had been calculated as a function of the extended signal vector and added to the extended signal vector.

The invention will be described hereinafter in more detail with the aid of a preferred embodiment with reference to the accompanying drawings.

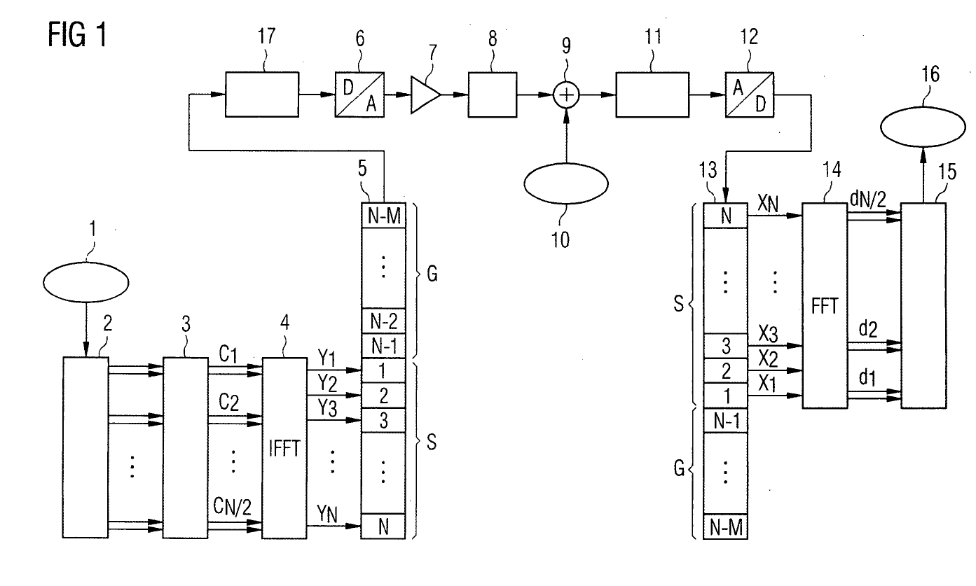

FIG. 1 shows the schematic construction of a circuit arrangement for data transmission by discrete multitone modulation,

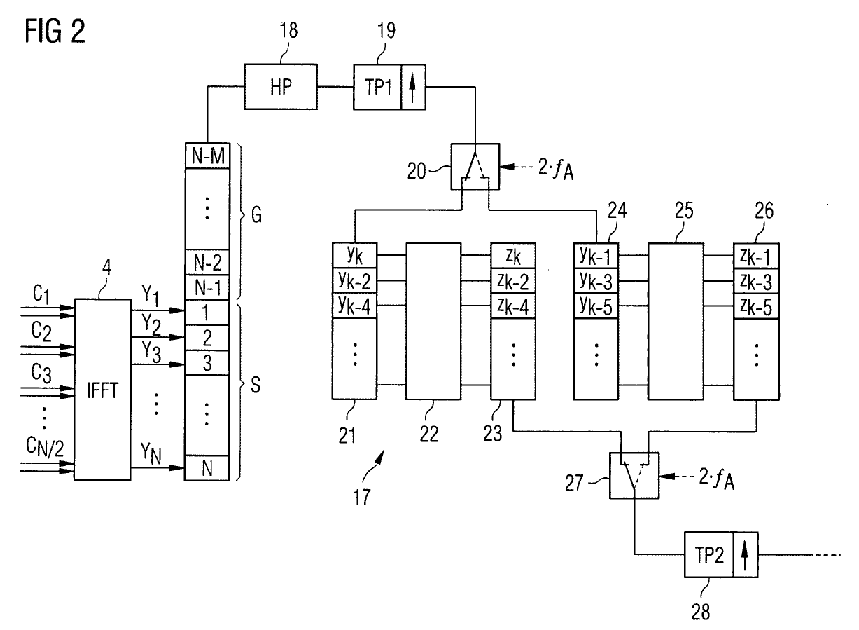

FIG. 2 shows a detail of the circuit arrangement according to FIG. 1 which reproduces in more detail the components for reducing the crest factor in an embodiment at doubled sampling frequency,

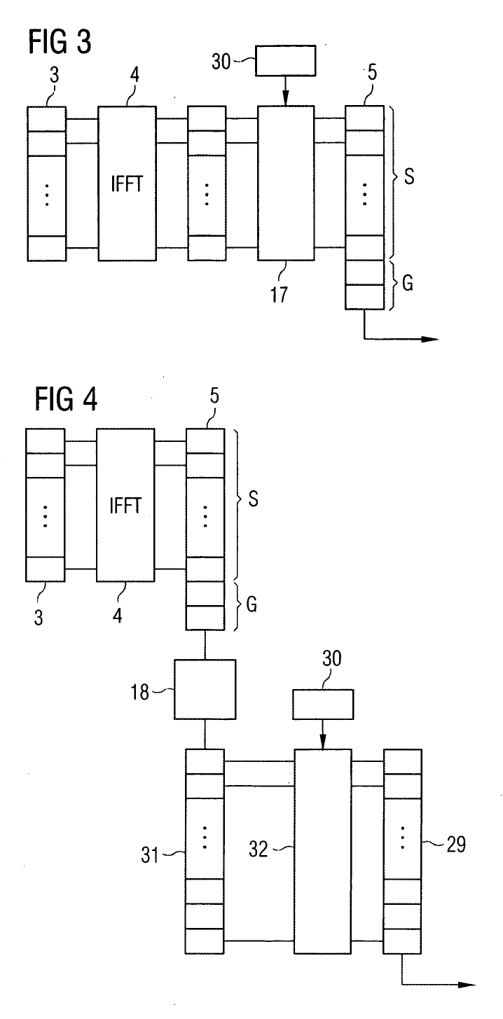

FIG. 3 shows components for reducing the crest factor with subsequent addition of a guard interval,

FIG. 4 shows components for reducing the crest factor, a guard interval being added for superimposition with a correction factor,

FIG. 5 shows different arrangements of a window area of a window function with reference to a signal vector,

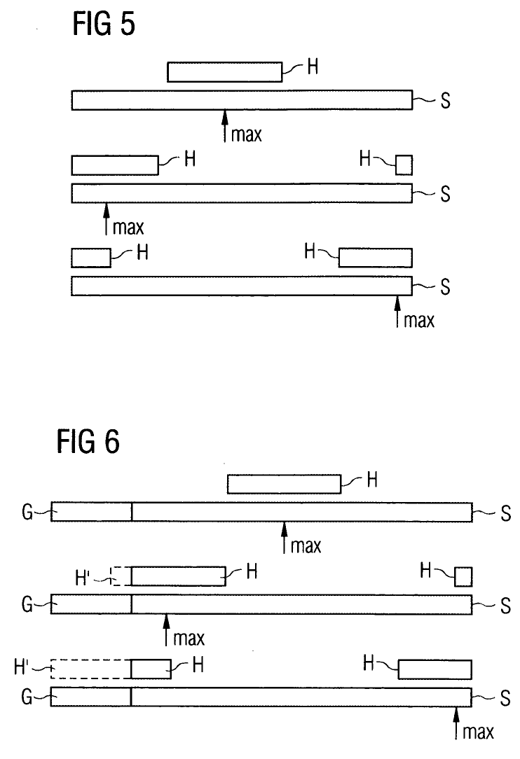

FIG. 6 shows different arrangements of a window area of a correction vector with reference to a signal vector extended by a guard interval,

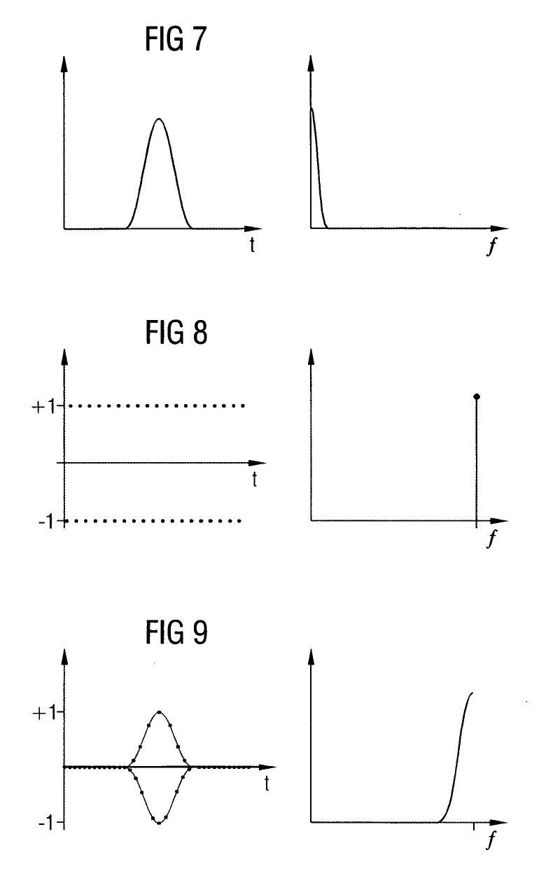

FIGS. 7 to 9 show time sequences and spectra of a window function, a base vector and the windowed base vector, and

FIG. 10 shows the amplitude distribution of the transmitting signal in discrete multitone modulation.

The circuit arrangement shown schematically in FIG. 1 describes a system for data transmission by the method of discrete multitone modulation. A data source 1 transmits digital data here, serially to a first serial/parallel converter 2 which divides the serial data into data blocks with N/2 part blocks in each case. The number N describes the number of elements of the signal vector used for data transmission in the time domain.

The part blocks are transmitted in parallel to a coding device 3 which distributes each of the N/2 part blocks to a respective carrier frequency of the N/2 carrier frequencies available for data transmission and therefore generates a first digital signal vector in the frequency domain with N/2 elements C₁, C₂, . . . , C_{N/2} for amplitude and phase modulation of a respective frequency.

From this signal vector in the frequency domain, a first inverse Fourier transformation 4 generates by an inverse fast Fourier transformation a signal vector y in the time domain with N elements y1, y2, . . . , yN (corresponding to the N sampling values). The N elements of the signal vector y1, y2, . . . , yN in the time domain correspond here to N sampling values of the signal to be transmitted. The signal vector y1, y2, . . . , yN has a high crest factor in the time domain here. This is to be changed and, in particular, reduced.

The signal vector y1, y2, . . . , yN in the time domain is transmitted in parallel to a parallel/serial converter 5, in that a prefix is added in front of the signal vector y1, y2, . . . , yN. This prefix is formed from M elements of the signal vector y in the time domain, the M elements being located at the end of the signal vector y before the last element, so the elements y_{N-M} to y_{N-1} are placed in front of the original signal vector y1, y2, . . . , yN. The extended signal vector produced therefrom has N+M elements. This measure is also called a cyclic prefix. It is achieved by the prefix that the transient effects are substantially concluded on the receiver side by the beginning of the signal vector y1, y2, . . . , yN and the equalisation can be simplified.

The extended signal vector in the parallel/serial converter 5 is transmitted serially to a correction device 17 which serves to reduce the crest factor and is described below in detail. The correction device 17 supplies output data serially to a digital/analogue converter 6, the analogue output signal of which is amplified by a transmitting amplifier 7 to transmit via a transmission channel 8. In the process, the transition signal from the transmission channel 8 is linearly distorted and superimposed by an addition 9 from a noise component 10. The noise can occur here at many points, for example in the transmission channel 8 owing to crosstalk in the transmitting amplifier 7 or in the digital/analogue converter 6.

There is an equaliser 11 on the receiver side, to which the transmitted signal is supplied and which equalises the signal and passes it to an analogue/digital converter 12.

The digital output signal of the analogue/digital converter 12 is supplied serially to a serial/parallel converter 13 which can receive the elements of the signal vector y extended by the prefix. The signal vector with prefix is shifted through to the end in the serial/parallel converter 13, wherein at the end of the shifting operation the prefix is located at the end of the serial/parallel converter 13 and the original signal vector behind it. Only the original signal vector without prefix is transmitted from the serial/parallel converter 13 in parallel as the received signal vector x1, x2, . . . , xN to a second Fourier transformer 14. The received signal vector x1, x2, . . . , xN in the time domain is transmitted back into the frequency domain by the second Fourier transformer 14 by fast Fourier transformation and supplies a received signal vector d1, d2, . . . , dN/2 in the frequency domain with N/2 elements. The receiving signal represented by the signal vector is thus displayed on the various carrier frequencies of the discrete multitone modulation. The received signal vector in the frequency domain d1, d2, . . . , dN/2 is supplied to a receiving stage 15 which calculates the digital data from the amplitude and the phase of the carrier frequencies and supplies them to a data sink 16.

FIG. 2 shows in detail a section of the circuit arrangement according to FIG. 1 around the correction device 17. As described above, the first Fourier transformer 4 supplies a signal vector y in the time domain which is provided in the parallel/serial converter 5 with a prefix and output serially as an extended signal vector in the time domain. The extended signal vector in the time domain passes through a digital high-pass filter 18, in which the spectral components in a lower frequency range which is used for transmitting telephone conversations via telephone line, are removed. The signal vector then passes through a first low-pass filter 19 which removes the spectral components above the Nyquist frequency. For this purpose, in the first low-pass filter 19 the sampling frequency is doubled which is signalled by the upwardly directed arrow. The extended signal vector in the time domain with the doubled sampling frequency f_{A} and therefore double the number of elements is therefore at the output of the first low-pass filter 19. The output signal of the first low-pass filter 19 is guided to a first commutator 20 which, in the clock pulse of the doubled sampling frequency f_{A} divides the elements over two part signal vectors which are each loaded into one of two part signal vector registers 21, 24. The elements of the extended signal vector from the output of the first low-pass filter 19 are then alternately distributed over the two part signal vectors. The first part signal vector therefore receives the elements of the extended signal vector which has been doubled with respect to sampling frequency in the time domain with an even time index, in other words the elements yₖ, yₖ₋₂, yₖ₋₄, . . . , whereas the second part signal vector contains the elements with an uneven time index yₖ₋₁, yₖ₋₃, yₖ₋₅, . . . , wherein k is the running index for the elements of the extended signal vector which has been doubled with respect to sampling frequency and therefore runs to 2N.

The two part signal vector registers 21 and 24 supply the two part signal vectors yₖ, yₖ₋₂, . . . , and yₖ₋₁, yₖ₋₃, . . . , to a first and second part correction device 22 or 25, respectively. In each of these two part correction devices 22 and 25, a correction vector is calculated as a function of the respective part signal vector present, is superimposed on the signal vector or added thereto and a part output vector z is output as a result of this superposition. A first part output vector with an even time index having the elements zₖ, zₖ₋₂, zₖ₋₄, . . . , is generated by the first part correction device 22. The part output vector generated by the second part correction device 25 comprises the elements with uneven time index zₖ₋₁, zₖ₋₃, zₖ₋₅, . . . . The two part output vectors are written parallel to the part output registers 23, 26 from which they can be serially output. The output signals of the two part output registers 23, 26 are guided to a second commutator 27 which is clocked synchronously to the first commutator 22 with double the sampling frequency 2f_{A} and the elements of the two part output vectors are alternately joined in the two part output registers 23, 26 to form a single vector which again comprises 2N elements. The extended signal vector doubled with respect to the sampling frequency and supplied by the first low-pass filter 19 is therefore at the output of the second commutator 27 in the time domain in which a reduction of the crest factor was also undertaken.

The same operation which is described below, takes place inside each of the two part correction devices 22, 25.

A correction vector is basically used which has only spectral components at the sampling frequency f_{A/2}, so it can be generated by scaling a vector with the elements +1, −1, . . . . This sequence of alternately +1 and −1 is scaled such that a maximum value in the part signal vector and also the crest factor is reduced. Simultaneously, the information in the frequency channels is not disturbed by a correction vector of this type as a correction vector of this type only adds frequency components at the Nyquist frequency which is not used for data transmission.

To describe the calculation of a correction vector, a new running index i is to be introduced hereinafter which continuously numbers the elements of a part signal vector. This new running index i runs from 1 to N. The correction vector for the first part signal vector should be denoted Δy1 and the first part signal vector y1. Proceeding therefrom, the first correction vector Δy1 is calculated as follows:

$$Δ {y1}_{i} = - \frac{1}{2} \cdot {( - 1 )}^{i} ( max ( {( - 1 )}^{i} \cdot {y1}_{i} ) + min ( {( - 1 )}^{i} \cdot {y1}_{i} ) )$$

In this instance, max designates the largest element of a vector and min the smallest element of a vector. The second correction vector for use in the second part correction device 25 is calculated analogously, wherein a second part signal vector y2ᵢ containing the elements yₖ₋₁, yₖ₋₃, yₖ₋₅, . . . , takes the place of the first part signal vector y1ᵢ. A second correction vector Δy2ᵢ is calculated in a corresponding manner.

The two calculated correction vectors Δy1 and Δy2 are multiplied by a window function w which only differs from zero in one, or in certain circumstances, two ranges, so that large ranges of the two correction vectors are made into zero or masked out. The window function is selected such that it widens the spectrum of the correction vectors Δy1, Δy2 as little as possible, but nevertheless has a narrow window area in which the values differ from zero.

The time curve of a window function of this type is shown schematically in FIG. 7 on the left. On the right thereof in the graph, the spectrum of the window function shown is depicted. The spectrum has a maximum at zero and runs to increasing frequencies within a narrow range. The two correction vectors Δy1, Δy2 are discrete-time and have a time curve as is shown in FIG. 8 on the left. As the envelope curve of the unwindowed correction vectors and the signal described by the two correction vectors Δy1, Δy2 have no ripple factor, the correction vector shown in FIG. 8 on the left has only a narrow spectral range as is depicted in the graph shown in FIG. 8 on the right.

FIG. 9 shows, on the left, the time curve of the correction vector according to FIG. 8 windowed by the window function according to FIG. 7, the upper and lower envelope curve of the signal being shown with a thin continuous line. The associated curve of the spectrum is shown on the right in FIG. 9. As can be seen, the original spectrum of the correction vector widens according to FIG. 8. This has the result that owing to the addition of the now windowed correction vectors Δy1, Δy2 to the respective part signal vectors, more spectral components are added than would have been the case with unwindowed correction vectors, and therefore more frequencies of the signal vector are disturbed and made unusable for information transmission. Conversely, however, the advantage is obtained that the two part signal vectors Δy1, Δy2 and a signal vector which has not been divided can be corrected in a targeted manner only at one position which is determined by the position of the window area in the window function.

The elements of the correction vector Δy_{μ} are advantageously calculated, however, within a window area with the index μ of the window function w as follows:

Δy_{μ}=−Vz·dₒₚₜ·(−1)^{μ}·w(μ).

In this instance that which was stated at the outset applies to the factors Vz and dₒₚₜ and the running index μ. Outside the window area the elements of the correction vector are zero.

Three different cases of the arrangement and superimposition of the window area H with respect to the maximum element of the signal vector S are shown in FIG. 5. The position of the maximum element within the signal vector S is denoted by an arrow directed upwardly and with the word max. The window area (H) is placed such that its centre is located at the maximum element of the signal vector S. Three cases are produced therefrom. If the spacing of the maximum element max from the front and back end of the signal vector S is greater than half the window area H the case depicted above is produced and the window area H is arranged undivided at the correct position. The arrangement of the window area H equally means that a correction vector windowed with this window area H only has elements differing from zero in this range and therefore is only added in this range to the elements of the signal vector S.

If the maximum element max is located close to the beginning of the signal vector S, as is shown in the centre case, part of the window area has to be cut off at the beginning. This cut off part is arranged over the end of the signal vector S so the original window area is assembled again with cyclical updating of the signal vector together with the window area.

The same is true for the third case shown below, in which the maximum element max is located at the end of the signal vector S. In this case, the end of the window area is cut off and arranged over the beginning of the signal vector S so the entire window area H is assembled again with cyclical updating of the signal vector S.

In the method described above, a signal vector S was started from which is not lengthened by a guard interval. Hereinafter, the cases shown in FIG. 6 are to be considered in which the signal vector is extended at the front by a guard interval G. The guard interval G at the front end is a copy of the back end of the signal vector S. In the case shown at the top of FIG. 6 there is no change relative to the case shown at the top of FIG. 5, as the window area H lies completely within the signal vector S owing to the position of the maximum element max of the signal vector S.

In the case shown in the centre in FIG. 6, the maximum element max lies at the beginning of the signal vector S, so the window area H arranged above it extends beyond it to the front. This projecting part is added at the end in the corresponding case in FIG. 5, wherein simultaneously the projecting part H′ of the window area also continues into the guard interval G and remains there. The same applies to the case shown in FIG. 6, in which the maximum element max is located at the end of the signal vector. To summarise, it can be established that the window area H has to be superimposed on a signal vector X extended with a guard interval G such that after the superimposition the same total vector is produced as would be produced with the addition of a guard interval G to a signal vector S already superimposed by the correction vector.

FIG. 2 describes the reduction of the crest factor after a doubling of the sampling frequency f_{A} with a division of the elements of the signal vector S with guard interval G over two part signal vectors. This procedure is recommended owing to the doubling of the sampling frequency f_{A}.

An alternative embodiment is shown in FIG. 3, in which the correction vector is added to the signal vector S before the addition of the guard interval G. As in the above embodiments, the coding device 3 supplies the signal vector in the frequency domain to the inverse Fourier transformer 4 which at the output applies the signal vector S in the time domain directly to a correction device 17. A suitable correction vector is calculated therein and multiplied or windowed by a window function supplied by a window device 30. The windowed correction vector is then added to the signal vector S, the length of the maximum element within the signal vector S being taken into account. The signal vector S supplied by the correction device 17 and reduced with respect to the crest factor is supplied to the parallel-serial converter 5 with the guard interval 5 being added.

FIG. 4 shows a further embodiment, the guard interval G being added prior to the addition of the correction vector. After the parallel-serial converter 5, the signal passes through a low-pass filter 18, in which the sampling frequency f_{A} is not doubled, however. The output signal of the low-pass filter 18 is guided into a serial-parallel converter 31 which passes the filtered signal vector provided with guard interval G to a correction device 32 which calculates a correction vector and windows it by means of a window function supplied by a window device 30. The calculated correction vector is added thereto and the total vector is serially output via an adjacent parallel-serial converter 29. As in this case, the correction device 32 is supplied with the signal vector S already extended by the guard interval G, as the input signal, that stated in conjunction with FIG. 6 has to be taken into account, according to which, parts of the window area H which fall within the guard interval G occur there and simultaneously also have to be added to the opposing end of the signal vector.

In all embodiments, a windowed correction vector is calculated a plurality of times in succession and additively superimposed on the signal vector, the position of the window area being coordinated in each case with the position of the largest element in the signal vector in the respective step.

1. Method for changing the crest factor of a discrete-time signal which is formed by temporally consecutive signal values of a signal vector, in which method at least one correction vector is calculated as a function of the signal vector and is added to the signal vector, wherein the elements of the at least one correction vector describe a signal, the upper and/or lower envelope curve of which has at least one local extreme value.

2. Method according to claim 1, wherein the upper and/or lower envelope curve has at least one local maximum.

3. Method according to claim 1, wherein the upper and/or lower envelope curve has at least one local minimum.

4. Method according to claim 1, wherein the correction vector is calculated by multiplication of a base vector by a window function.

5. Method according to claim 4, wherein the window function has at least one window area of consecutive elements, in which the values of the window function differ from zero, the values of the window function outside the at least one window area being zero.

6. Method according to claim 5, wherein a window area interrupted by a first end of the correction vector is continued at the other second end of the correction vector.

7. Method according to claim 4, wherein the window functions describe a rectangular window, a triangular window, a Von-Hann window, a Gauss window, a Hamming window or a Blackman window.

8. Method according to claim 4, wherein the at least one window area of the window function is arranged with respect to the temporal sequence of the elements of the correction vector in such a way that a maximum value of the signal vector lies inside the window area.

9. Method according to claim 4, wherein the base vector only contains frequency components which lie at the edges of a useful spectrum which extends from a low frequency, in particular the frequency zero to half the sampling frequency of the signal vector.

10. Method according to claim 9, wherein the elements of the base vector alternately adopt one of two values.

11. Method according to claim 1, wherein a correction vector is repeatedly calculated and added to the signal vector and the envelope curve of the signals described by the correction vectors used have their at least one local extreme value at different positions.

12. Method according to claim 11, wherein after the first addition of a correction vector to the signal vector, the following correction vectors are calculated as a function of the total vector produced by the preceding addition.

13. Method according to claim 1, wherein the signal is a carrier of data, wherein all spectral components of data lie below the sampling frequency of the signal divided by 2^{N-1}, wherein the signal values of the signal vector are divided after filtering in a cyclically alternating manner over 2^{N} part signal vectors and for each part signal vector at least one correction vector is calculated independently from the respective part signal vector and added to the respective part signal vector, and then the elements of the part signal vector are combined in a cyclically alternating manner to form an output signal vector, wherein N is integral and >=1.

14. Method according to claim 4, wherein the elements of the base vector are calculated from the largest element and the smallest element of the elements of the digital signal vector as follows:
$$Δ {{y}^{′}}_{k} = - \frac{1}{2} \cdot {( - 1 )}^{k} ( max ( {( - 1 )}^{k} \cdot {y}_{k} ) + min ( {( - 1 )}^{k} \cdot {y}_{k} ) ) ,$$
where k=1, . . . , number of the elements of the signal vector.

15. Method according to claim 4, wherein the elements of the base vector are calculated from the largest element and the smallest element of the elements of the digital signal vector as follows:
$$Δ {{y}^{′}}_{k} = - \frac{1}{2} \cdot ( max ( {y}_{k} ) + min ( {y}_{k} ) ) ,$$
where k=1, . . . , number of the elements of the signal vector.

16. Method according to claim 4, wherein the elements of the correction vector Δy_{μ} in the window area are calculated as follows:
Δy_{μ}=−Vz·dₒₚₜ·(−1)^{μ}·w(μ),
wherein μ is the running index in the window area and goes from 0 to M−1, w(μ) is the window function, Xh is an auxiliary vector with the running index μ and the elements of the signal vector in the window area, the maximum element Xhₘₐₓ of the auxiliary vector is located at the position ½*(M−1)+1, Vz equals
$$Vz = sign ( Xh ( \frac{M - 1}{2} + 1 ) )$$
and dₒₚₜ is calculated as follows:
$${d}_{opt} = Min ( \frac{{Xh}_{max} + {Xh}_{μ}}{1 + w ( μ )} ) .$$

17. Method according to claim 4, wherein the elements of the correction vector Δy_{μ} in the window area are calculated as follows:
Δy_{μ}=−Vz·dₒₚₜ·w(μ),
wherein μ is the running index in the window area and goes from 0 to M−1, w(μ), is the window function, Xh is an auxiliary vector with the running index μ and the elements of the signal vector in the window area, the maximum element Xhₘₐₓ of the auxiliary vector is located at the position ½*(M−1)+1, Vz equals
$$Vz = sign ( Xh ( \frac{M - 1}{2} + 1 ) )$$
and dₒₚₜ is calculated as follows:
$${d}_{opt} = Min ( \frac{{Xh}_{max} + {Xh}_{μ}}{1 + w ( μ )} ) .$$

18. Method according to claim 1, wherein the signal vector at the beginning, at a first end, is lengthened by at least one element of the signal vector starting from the opposing second end of the signal vector.

19. Method according to claim 18, wherein the lengthening of the signal vector at the first end is carried out at the beginning of the method and the at least one correction vector is lengthened corresponding to the lengthening of the signal vector at a first end of the correction vector by at least one consecutive element of the correction vector starting at the opposing second end of the correction vector, so the correction vector and the signal vector are lengthened by the same number of elements.

20. Method according to claim 1, wherein the signal vector is calculated by inverse Fourier transformation.

21. Method according to claim 1, wherein the signal vector contains data according to the method of discrete multitone modulation.

22. Method according to claim 1, wherein the method for data transmission via telephone lines is used according to the ADSL standard.

23. Device for changing the crest factor of a discrete-time signal which is formed by temporally consecutive signal values of a signal vector, the device being set up such that it calculates at least one correction vector as a function of the signal vector and adds it to the signal vector, wherein the device is set up such that it calculates the at least one correction vector such that the elements of the at least one correction vector describe a signal, of which the upper and/or lower envelope curve has at least one local extreme value.

24. Device according to claim 23, wherein the device is set up for carrying out a method according to any one of claims 1 to 18.

25. Device according to claim 23, wherein the device is a signal processor.
